(19) United States
(12) Patent Application Publication
(10) Pub. No.: US 2008/0233985 A1
(43) Pub. Date: Sep. 25, 2008

(54) Telephone system, telephone set and portable device

(75) Inventor: Katsuhiro Sato, Kani-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/076,421

(22) Filed: Mar. 18, 2008

(30) Foreign Application Priority Data
Mar. 22, 2007 (JP) 2007-074422

(51) Int. Cl. H04Q 7/32

(52) U.S. Cl. 455/466

(57) ABSTRACT

A telephone system according to one aspect of the invention comprises: a portable device; and a telephone set with which the portable device can be registered as an additional device. The telephone system comprises a transmission unit configured to periodically transmit a beacon to the registered portable device, and an adding unit configured to add additional data containing at least one of audio data and visual data to the beacon to be transmitted from the transmission unit. The portable device comprises a reproduction unit configured to reproduce the additional data obtained from the beacon.

### CROSS-REFERENCE TO RELATED APPLICATIONS

This application is based upon and claims the benefit of priority from Japanese Patent Application No. 2007-074422, filed on Mar. 22, 2007, the entire contents of which are incorporated herein by reference.

### TECHNICAL FIELD

The present invention relates to a telephone system including a telephone set and a portable device.

### BACKGROUND

JP-A-7-212829 discloses a digital cordless telephone set including a main device and an additional device. The main device receives a digital music signal (music data) from a digital audio instrument or through an ISDN line, and transmits the digital music signal to the additional device via a wireless signal. Then, the additional device receives the digital music signal and reproduces the music over a built-in speaker.

However, the above cordless telephone set requires an additional radio communication device dedicated to transmit and receive digital music signals, which may increase cost.

### SUMMARY

Aspects of the present invention address the above disadvantages and other disadvantages not described above. However, the present invention is not required to overcome the disadvantages described above, and thus, an aspect of the present invention may not overcome any of the problems described above.

It is an aspect of the present invention to provide a telephone system capable of smoothly transmitting audio and/or visual data from a telephone set to a portable device without separately providing a wireless device to transmit and receive digital music signals.

According to an aspect of the invention, there is provided a telephone system comprising: a portable device; and a telephone set with which the portable device can be registered as an additional device, wherein the telephone system comprises a transmission unit configured to periodically transmit a beacon to the registered portable device, and an adding unit configured to add additional data containing at least one of audio data and visual data to the beacon to be transmitted from the transmission unit, and wherein the portable device comprises a reproduction unit configured to reproduce the additional data obtained from the beacon.

According to another aspect of the invention, there is provided a telephone set for use in a telephone system and configured to communicate with a portable device as an additional device in a telephone system, said telephone set comprising: a transmission unit configured to periodically transmit a beacon to the portable device; and an adding unit configured to add additional data containing at least one of audio data and visual data to the beacon to be transmitted from the transmission unit.

According to still another aspect of the invention, there is provided a portable device for use in a telephone system and configured to communicate with a telephone set that periodically transmit a beacon, said portable device comprising: a receiving unit configured to receive the beacon; a obtaining unit configured to obtain an additional data containing at least one of audio data and visual data from the beacon when the additional data is added to the beacon; and a reproduction unit configured to reproduce the additional data obtained from the beacon.

### BRIEF DESCRIPTION OF THE DRAWINGS

FIG. 1 is an external perspective view of a cordless extension telephone system including a main device and mobile devices;

FIGS. 2A and 2B are explanatory diagrams showing a structure of a beacon in which FIG. 2A shows a mode in which only one Tx (transmission) slot is active and FIG. 2B shows a mode in which three Tx slots are active;

FIG. 3 is a block diagram showing electrical configurations of the main device and the mobile devices; and

FIG. 4 is a flowchart for explanation of music reproduction processing by the cordless extension telephone system.

### DESCRIPTION

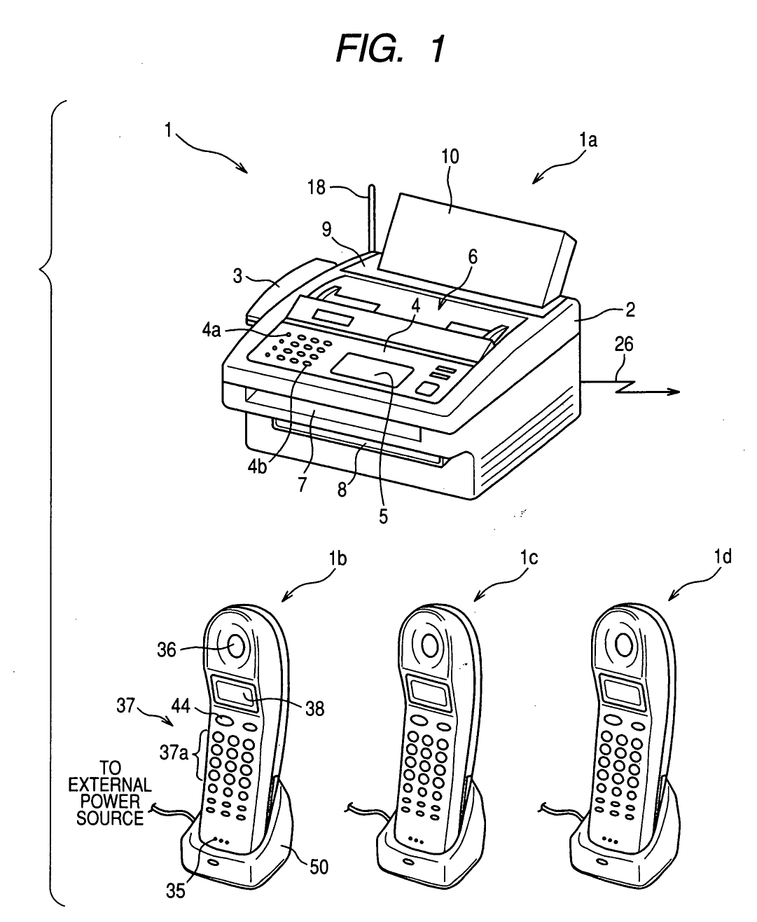

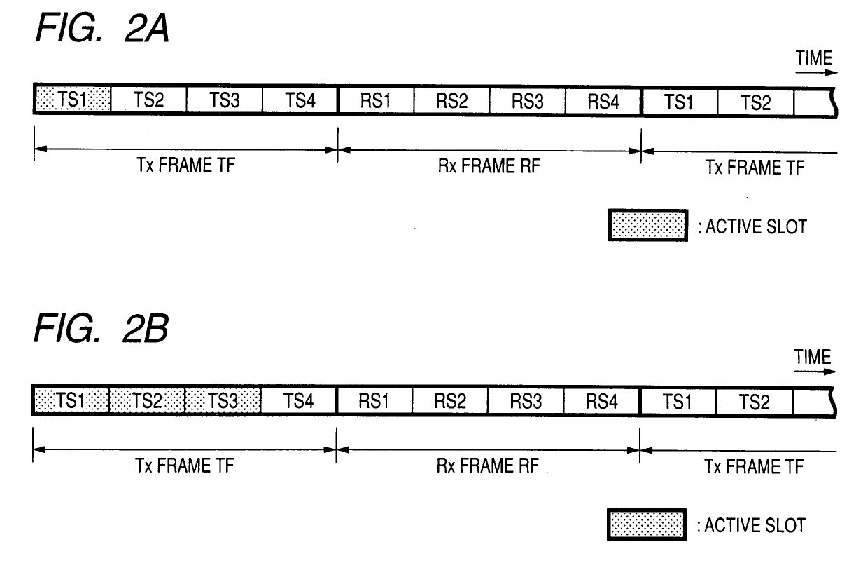

Next, an embodiment of the present invention will be described in detail with reference to the drawings. As reference drawings, FIG. 1 is an external perspective view of a cordless extension telephone system including a main device and mobile devices, and FIGS. 2A and 2B are explanatory diagrams showing a structure of a beacon. Here, FIG. 2A shows a mode in which only one Tx (transmission) slot is an active slot used for music data, and FIG. 2B shows a mode in which three Tx slots are active slots used for music data.

As shown in FIG. 1, a cordless extension telephone system 1 includes a main device la serving as one example of a telephone set, and a plurality of mobile devices 1b, 1c, and 1d capable of communicating with the main device 1a.

The main device 1a is a communication apparatus to perform a telephone operation, a facsimile operation, and transmission and reception of e-mail with apparatuses of other parties connected via a telephone line 26. A telephone receiver 3 is set on the lateral portion of a main body 2 of the main device 1a.

An operation panel 4 is provided at the front portion of the upper surface of the main body 2. The operation panel 4 includes a plurality of buttons such as input buttons to input numerical values and characters and command input buttons to input commands. A setting button 4a which serves as one of the command input buttons is provided at the left upper end of the operation panel 4. The setting button 4a allows a liquid crystal display device (hereinafter simply abbreviated as “LCD”) 5 to display an input screen in which various settings and commands are input. When the setting button 4a is pressed by an operator, the input screen is displayed on the LCD 5.

The LCD 5 is provided at the center portion of the operation panel 4. The LCD 5 includes a touch panel and displays processing to be executed by the main device 1a or a communication status of apparatuses on other parties connected via the telephone line 26. When the main device 1a is operated by buttons of the setting button 4a, a numeric keypad 4b etc provided on the operation panel 4, an operation status, an operation procedure, or the like is displayed on the LCD 5.

A document insertion portion 6 is provided behind the operation panel 4 and the LCD 5 A document for the facsimile transmission is inserted into the document insertion portion 6, and after the reading operation is performed, the document is discharged from a document discharging portion 7 provided at the front surface of the main body 2. A recording sheet holder mounting portion 9 is provided behind the document insertion portion 6, and a recording sheet holder 10 capable of housing a stuck of a plurality of recording sheets is detachably attached to the recording sheet holder mounting portion 9. A recording sheet supplied from the recording sheet holder 10 and used for printing is discharged from a recording sheet discharging portion 8 provided below the document discharging portion 7.

The main body 2 is provided with an antenna 18 serving as a connection unit to transmit/receive various signals and data to/from the mobile devices 1b to 1d. The main device 1a periodically transmits a beacon to the mobile devices 1b to 1d. The term “beacon” here means a packet transmitted at regular intervals from the telephone set such as a main device 1a in order to synchronize a telephone set (main device 1a) and portable devices (mobile devices 1b to 1d). In addition, the beacon is transmitted when the mobile devices 1b to 1d are in a standby mode. The mobile devices 1b to 1d in a standby mode receive the beacon. The beacon is a well-known technology, and the details thereof will be omitted. However, the structure is briefly described with reference to FIGS. 2A and 2B. As shown in FIG. 2A, a Tx (transmission) frame TF (packet) including four Tx slots TS1, TS2, TS3, and TS4 is transmitted as a beacon to the respective mobile devices 1b to 1d at regular intervals (a period of time by an amount of a Rx (reception) frame RF). The respective Tx slots TS1, TS2, TS3, and TS4 allows a predetermined data amount to be allocated. In the present embodiment, music data can be allocated to the respective Tx slots TS1, TS2, TS3, and TS4 in accordance with a data amount. That is, when a data amount is small, for example, as shown in FIG. 2A, music data is allocated to only the Tx slot TS1. When a data amount is large, for example, as shown in FIG. 2B, music data is allocated to the three Tx slots TS1, TS2, and TS3.

An interval between the intermittently transmitted respective Tx frames TF is set as a Rx frame RF. The Rx frame RF is set by the same period of time as one Tx frame, and includes four Rx (reception) slots RS1, RS2, RS3, and RS4. The respective Rx slots RS1 to RS4 allow signals to be transmitted from the mobile devices 1b to 1d (for example, signals generated by the mobile devices 1b to 1d due to operations of the mobile devices 1b to 1d) or the like to be allocated. That is, each of the mobile devices 1b to 1d transmits a signal to the main device 1a by using one of the four Tx slots, and the main device 1a receives the signal at the Rx slots RS1 to RS4.

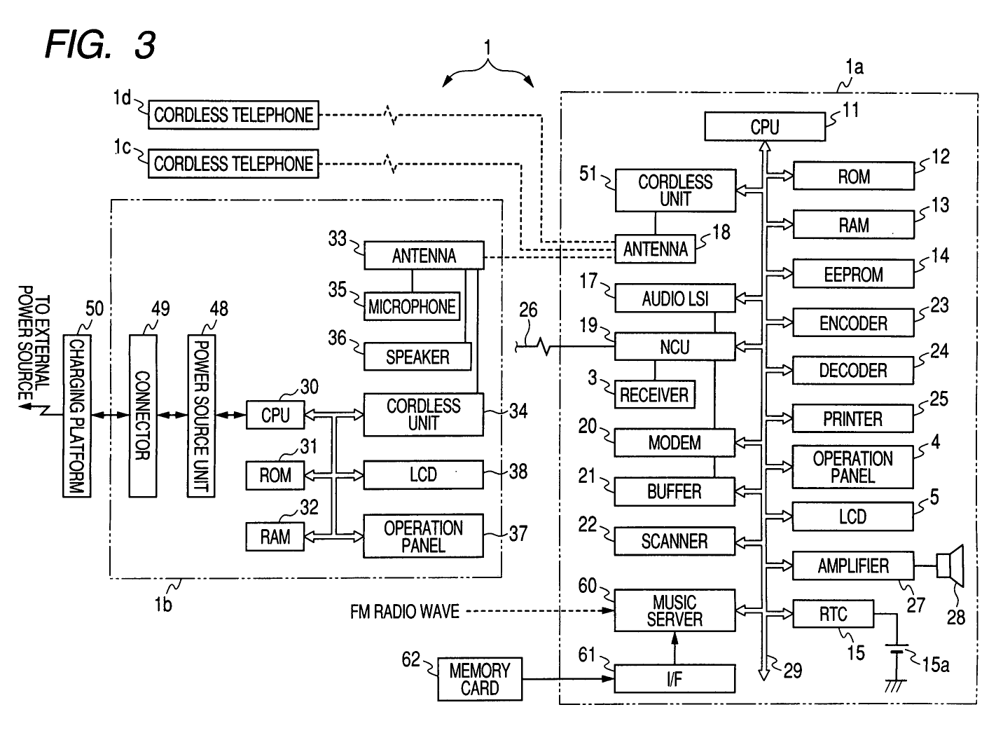

As shown in FIG. 1, each of the mobile devices 1b to 1d includes an antenna 33 (refer to FIG. 3) to transmit/receive data to/from the main device 1a. Each of the mobile devices 1b to 1d is connectable to the telephone line 26 via the main device 1a. When requesting a call to an external line, each of the mobile devices 1b to 1d transmits a command to the main device 1a, and the main device 1a executes an operation based on the command, thereby the call request is executed.

Each of the mobile devices 1b to 1d includes an operation panel 37 and an LCD 38 on the front surface of the case. A numeric keypad 37a with a plurality of keys to input numerical values and characters is provided on the center portion of the operation panel 37. On the left sides above the numeric keypad 37a, a start key 44 is provided. The start key 44 allows connect/disconnect to/from the telephone line 26.

A microphone 35 is provided on the lower side of the case of each of the mobile devices 1b to 1d and configured to convert audio signal (user's utterance) into electrical signal. A speaker 36 is provided on the upper side of the case of each of the mobile devices 1b to 1d and configured to convert electrical signal into audio signal. In accordance therewith, the mobile devices 1b to 1d are capable of perform a telephone call with a caller apparatus (an apparatus of the other party) via the telephone line 26. Each of the mobile devices 1b to 1d is detachably installed on a charging platform 50.

Next, electrical configurations of the main device la and the mobile devices 1b to 1d will be described. FIG. 3 is a block diagram showing electrical configurations of the main device and the mobile devices.

The main device 1a includes a CPU 11, a ROM 12, a RAM 13, an EEPROM 14, a real-time clock (hereinafter simply abbreviated as “RTC”) 15, an audio LSI 17, a cordless unit 51, a network control unit (hereinafter simply called as “NCU”) 19, a modem 20, a buffer 21, a scanner 22, an encoder 23, a decoder 24, a printer 25, the operation panel 4, the LCD 5, an amplifier 27, and a music server 60, which are connected one another via a bus line 29.

The NCU 19 is configured to perform line control, and the main device 1a is connected to the telephone line 26 via the NCU 19. The NCU 19 is configured to receive a ringing signal and various signals transmitted from an exchange, and configured to transmit a dial-up signal in an outgoing call according to an operation of the input buttons on the operation panel 4 of the main device 1a or the operation panels 37 of the mobile devices 1b to 1d. The NCU 19 is also configured to perform data communication such as transmission and reception of analog audio signals during connection of the telephone line 26. The NCU 19 is connected to the receiver 3.

The CPU 11 is configured to control the respective units connected by the bus line 29 in accordance with various signals transmitted and received via the NCU 19 and programs stored in the ROM 12, and to execute data communication such as a facsimile operation or a telephone operation.

The ROM 12 is a non-rewritable memory in which control programs executed by the main device 1a and the like are stored. In the present embodiment, the information stored in the ROM 12 includes a transmission program to periodically transmit a beacon to the mobile devices 1b to 1d, and an adding program to add music data obtained from the music server 60 to a beacon. In the adding program, when a music data amount to be added is too large to be accommodated in one Tx slot TS1, the excess data is allocated to be added to another Tx slots TS2 to TS4 sequentially. That is, this adding program allows music data to be added to the plurality of Tx slots TS1 to TS4 when music data is equal to or greater than a predetermined amount. Where the transmission program corresponds to one example of a transmission unit, and the adding program corresponds to one example of an adding unit.

The EEPROM 14 is a rewritable and nonvolatile memory, and data stored in the EEPROM 14 is retained even after the power source is turned off. The information stored in the EEPROM 14 includes information (for example, identification numbers) on the portable devices registered as the mobile devices 1b to 1d in accordance with operations of buttons such as the setting button 4a and the numeric keypad 4b.

The RAM 13 temporarily stores various types of data such as decoded facsimile data. In addition, the stored facsimile data is thereafter outputted to the printer 25. The outputted facsimile data is printed on a recording sheet by the printer 25, and is thereafter erased from the RAM 13.

The RTC 15 includes an IC (Integrated Circuit) to keep time to provide a current year, month, dates, days of weeks, hours, minutes, and seconds. Data of a date and time of reception is added to received facsimile data and the like on a basis of the value of the RTC 15, and it is possible to manage using a time of receipt. A battery circuit 15a is configured to supply a backup voltage when the power source of the main device 1a is turned off, and the battery circuit 15a is connected to the RTC 15. The RTC 15 is capable of continuing to operate by the battery circuit 15a even after the power source of the main device 1a is turned off.

The audio LSI 17 is configured to convert an analog audio signal received by the NCU 19 into a digital audio signal, and to convert the digital audio signal generated in the main device 1a into an analog audio signal to be outputted to the NCU 19.

The antenna 18 is configured to transmit and receive data between the main device 1a and the mobile devices 1b to 1d, and a beacon and various signals such as music data to be transmitted to the mobile devices 1b to 1d are transmitted via the cordless unit 51 and the antenna 18. On the other hand, data and various signals to be transmitted from the mobile devices 1b to 1d to the main device 1a are received via the antenna 18. The received data is inputted to the CPU 11 via the cordless unit 51.

The cordless unit 51 is configured to transmit and receive a beacon, music data, or the like as a radio wave. This cordless unit 51 has a digital/analog converter which is not shown in the figure.

The modem 20 is configured to modulate and demodulate image data and e-mail data, and to transmit and receive various procedure signals for transmission control.

The buffer 21 is configured to temporarily store encoded facsimile data transmitted and received with another facsimile device and image data of a document read by the scanner 22.

The scanner 22 is configured to read an image of a document inserted into the document insertion portion 6, and the encoder 23 is configured to encode the image of the document read by the scanner 22. The decoder 24 is configured to read out the received facsimile data stored in the buffer 21, and to decode the read out data. The decoded data is once stored in the RAM 13, and is thereafter printed on recording sheets sequentially.

The operation panel 4 is configured to receive inputs for various operations such as a setting of the main device 1a from outside such as users. For example, the operation panel 4 is operated to register predetermined portable devices as mobile devices. Also, the operation panel 4 is operated to select a delivery destination of a beacon to which music data is added (at least one of the mobile devices 1b to 1d), to select music data in the music server 60, and to select a delivery mode, and the like. In the embodiment, the term “delivery mode” is referred to as a mode to which the mobile devices 1b to 1d having been reproducing music prior to a reception of an incoming call becomes after the incoming call is finished. In the present embodiment, the delivery mode includes a reproduction mode in which music reproduced before an incoming call is again reproduced, and a standby mode in which a mobile device is returned to a normal state in which music is not reproduced.

The amplifier 27 is configured to output ringing tones, voice messages, music, and the like by sounding a speaker 28 connected to the amplifier 27.

The music server 60 is configured to receive FM radio waves from the outside, and is also configured to receive music data (digital data) from a memory card 62 via a memory card interface (hereinafter simply abbreviated as “I/F”) 61. The power source of the music server 60 turns ON and OFF according to operation of the operation panel 4. When the power source is turned ON, after FM modulated analog music data transmitted on an FM radio wave is demodulated to be converted into music data (digital data) by a predetermined device, and this data is temporarily stored in a memory unit. Music data (digital data) may be retrieved from the memory card 62, and the retrieved data is temporarily stored in the memory unit. The music data in the memory unit of the music server 60 can be retrieved by the CPU 11 and the CPU 11 converts the retrieved music data into data strings to be transmitted to the mobile devices 1b to 1d, and adds data strings to a beacon to be outputted to the cordless unit 51.

Next, the electrical configurations of the mobile devices 1b to 1d will be described by use of the mobile device 1b. Since the mobile devices 1c and 1d are structured in the same way as the mobile device 1b, descriptions thereof will be omitted.

The mobile device 1b includes a CPU 30, a ROM 31, a RAM 32, a cordless unit 34, the operation panel 37, and the LCD 38, which are connected to one other.

The CPU 30 is configured to execute a telephone operation and the like (including data communication with the main device 1a) by controlling the respective units in accordance with a signal inputted through the operation panel 37, various signals transmitted from the main device 1a via the cordless unit 34, and programs stored in the ROM 31.

The ROM 31 is a non-rewritable memory in which a control program and the like executed by the mobile device 1b are stored. In the present embodiment, the information stored in the ROM 31 includes an obtaining program to obtain music data from a beacon transmitted from the main device 1a, and a reproduction program to output the music data obtained from the beacon to allow the speaker 36 to reproduce the music. The term “reproduction program” here corresponds to one example of a reproduction unit. The RAM 32 is a memory in which various types of data are temporarily stored.

The antenna 33 is configured to transmit and receive radio waves between the mobile device 1b and the main device 1a, and is connected to the cordless unit 34, the microphone 35 and the speaker 36. An analog audio signal transmitted from the main device 1a is received by the antenna 33, and is thereafter outputted to the speaker 36. An analog audio signal (user's utterance) inputted from the microphone 35 is transmitted from the antenna 33 to the main device 1a. In addition, a beacon transmitted from the main device 1a is received by the antenna 33, and is thereafter transmitted to the CPU 30 via the cordless unit 34. When the beacon is received, the CPU 30 determines whether or not music data is added to the beacon. If music data is added to the beacon, the CPU 30 obtains the music data from the beacon, and the music data is converted into analog music data by the cordless unit 34 to be outputted to the speaker 36.

The cordless unit 34 is configured to communicate with the main device 1a to transmit and receive music data, audio signals, and data signals as radio waves. Various signals to be transmitted from the mobile device 1b to the main device 1a are transmitted via the antenna 33 from the cordless unit 34, and on the other hand, various signals to be transmitted from the main device 1a to the mobile device 1b are received by the antenna 33 thereafter inputted to the CPU 30 via the cordless unit 34. The cordless unit 34 has a digital/analog converter (not shown).

The mobile device 1b is connectable to the charging platform 50 via a connector 49. When the mobile device 1b is connected to the charging platform 50 through the connector 49, the mobile device 1b receives electric supply from an external power source. The supplied power source is supplied through the connector 49 to a power source unit 48 built in the mobile device 1b. A secondary battery is provided in the power source unit 48, and the secondary battery is charged with the supplied power source. Since the mobile device 1b receives electric supply from the power source unit 48, even when the mobile device 1b is picked up from the charging platform 50 to be operated, a power source is assured (by the secondary battery provided in the power source unit 48).

The LCD 38 and the operation panel 37 have the same or similar functions as those of the main device 1a. That is, the user can operate the operation panel 37 while looking at the LCD 38 to select a delivery destination of music data, to select music data in the music server 60, to select a delivery mode, and the like.

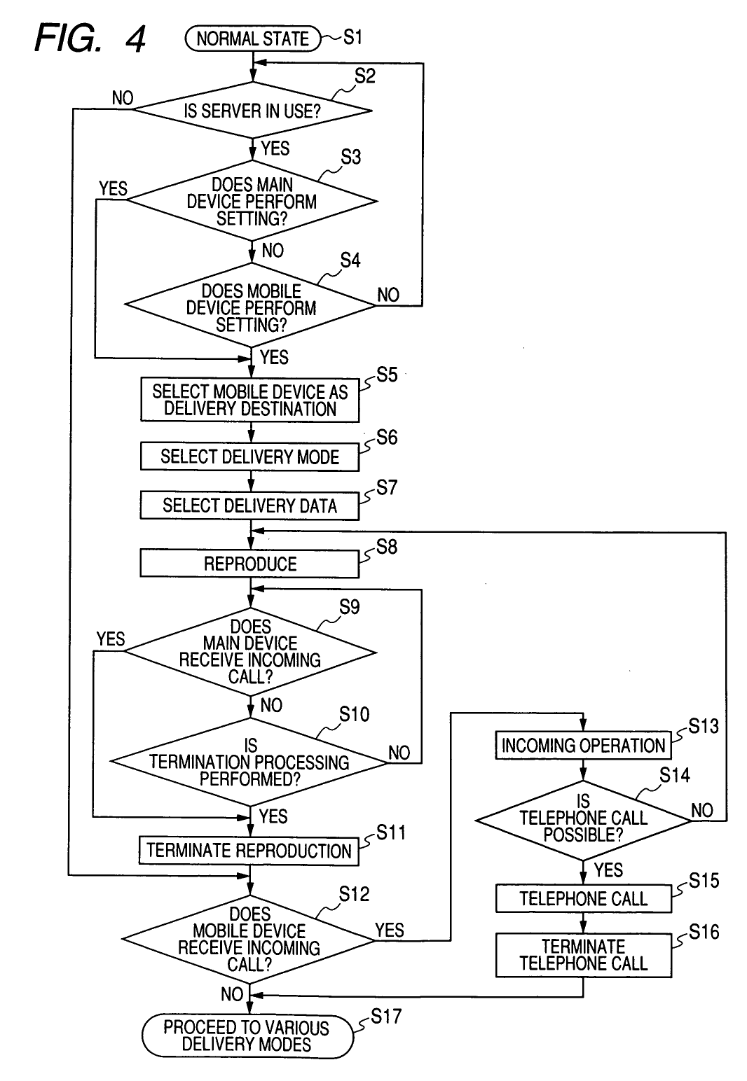

Next, a method for reproducing music by the cordless extension telephone system 1 configured as described above will be described with reference to a flowchart of FIG. 4. FIG. 4 is a flowchart for explanation of music reproduction processing by the cordless extension telephone system.

As shown in FIG. 4, first, at step S1 in a normal state, mainly, the CPU 11 of the main device 1a periodically transmits a beacon to the respective mobile devices 1b to 1d. In addition, at this step S1, control for proceeding to step S2 is periodically performed.

At step S2, the CPU 11 of the main device 1a determines whether or not a signal generated from the music server 60 in ON-state is received, which makes it determine whether or not the music server 60 is being used. At step S2, when it is determined that the music server 60 is being used (S2; Yes), the CPU 11 of the main device 1a determines whether or not a signal outputted from the setting start button due to pressing a predetermined setting start button on the operation panel 4 of the main device 1a is received, which makes it determine whether or not various settings start to be performed from the main device 1a (S3).

At step S3, when it is determined that various settings are not performed from the main device 1a (No), the CPU 11 of the main device 1a determines whether or not a signal of setting transmitted to the main device 1a by pressing a predetermined setting start button of the mobile devices 1b to 1d (S4), which makes it determine whether or not various settings start to be performed from the mobile devices 1b to 1d (S4). At step S4, when it is determined that various settings are not performed from the mobile devices 1b to 1d (No), the CPU 11 of the main device 1a returns to the processing at step S2.

When it is determined that various settings are performed from the main device 1a (S3; Yes), or when it is determined that various settings are performed from the mobile devices 1b to 1d (S4; Yes), the CPU 11 of the main device 1a selects various settings on the basis of various signals transmitted from the mobile devices 1b to 1d by operation with respect to the operation panel 4 of the main device 1a and the operation panels 37 of the mobile devices 1b to 1d. Specifically, the CPU 11 of the main device 1a selects a mobile device to be a delivery destination (S5), a delivery mode (S6), and music data (S7). For example, the CPU 11 of the main device 1a selects the mobile device 1b among the three mobile devices 1b to 1d, and selects a reproduction mode among the two delivery modes (the reproduction mode and the standby mode), and selects predetermined data among multiple music data stored in the memory unit of the music server 60.

After step S7, the CPU 11 of the main device 1a reproduces the selected music data over the speaker 28 via the audio LSI 17. Also, the CPU 11 adds the selected music data to a beacon, and transmits the beacon to a mobile device as a delivery destination. Here, when a data amount of the selected music data is large, at the time of adding the music data to the beacon, the CPU 11 of the main device 1a allocates the music data to the plurality of Tx slots TS1 to TS4 sequentially. In accordance therewith, the predetermined music is satisfactorily reproduced on the main device 1a and the mobile device as a delivery destination.

Then, during such reproduction, the CPU 11 of the main device 1a determines whether or not a predetermined ringing signal is received from an external exchange via the telephone line 26, which makes it determine whether or not there is an incoming call to the main device 1a (S9). At step S9, when it is determined that there is no incoming call (No), the CPU 11 of the main device 1a determines whether or not a predetermined signal outputted from the stop button by pressing a predetermined stop button on the operation panel 4 of the main device 1a or the operation panels 37 of the mobile devices 1b to 1d is received, which makes it determine whether or not processing of terminating the reproduction is performed by the user. When it is determined that there is an incoming call at step S9 (Yes), or when it is determined that processing of terminating the reproduction is performed at step S10 (Yes), the CPU 11 of the main device 1a turns the power source of the music server 60 off, which terminates the reproduction of the music on the main device 1a and the mobile devices 1b to 1d.

After step S11 or “No” at step S2, the CPU 11 of the main device 1a and the CPUs 30 of the mobile devices 1b to 1d determine whether or not an incoming signal is received from the main device 1a (S12). Here, since the processing of making a transition from step S11 to step S12 (i.e., a transition from communication through a beacon to communication at a radio wave for telephone call), and the processings from step S12 to step S14 (in a telephone mode) are well-know technologies, the detailed descriptions thereof will be omitted.

When it is determined that an incoming signal is received at step S12, the CPUs 30 of the mobile devices 1b to 1d output ring alert information to the speakers 36 to generate a ring alert over the speakers 36 (S13). Thereafter, the CPUs 30 of the mobile devices 1b to 1d determine whether or not a telephone call is made possible by pressing the start key 44 (refer to FIG. 1) (S14), and when it is determined that a telephone call is possible, a telephone call by the mobile device is started (S15). In addition, when it is determined that a telephone call is impossible (for example, in a case in which the start key 44 is not pressed for a predetermined time, or the line is disconnected from the other party), the CPUs 30 of the mobile devices 1b to 1d return to the processing at step S8.

When the user who is making a telephone call at step S15 presses the start key 44 again, and closes the telephone by hanging up one of the mobile devices 1b to 1d on the charging platform 50, the CPUs 30 of the mobile devices 1b to 1d determine that the telephone call is terminated (S16). Then, after step S16, the CPU 11 of the main device 1a makes a transition to the delivery mode selected at step S6. That is, when a reproduction mode is selected as a delivery mode, the process proceeds to step S7, and when a standby mode is selected, the process proceeds to a transition to step S1.

In accordance with the above-described descriptions, the following advantageous effects can be obtained in the present embodiment.

The music data is added to a beacon periodically transmitted from the main device 1a to the mobile devices 1b to 1d, which enables a smooth transmission of the music data without separately providing a wireless device dedicated to transmit and receive music data (a digital music signal).

The music data may be added to a plurality of Tx slots TS1 to TS4 when music data is greater than or equal to a predetermined amount. Therefore, it is possible to easily respond thereto even when a music data amount is large.

The present invention is not limited to the above embodiment, and can be utilized in various modes as exemplified hereinafter.

In the above embodiment, a plurality of Tx slots TS1 to TS4 are used as active slots when a music data amount is large. The present invention is not limited thereto. For example, different music data (e.g., different songs or music data of different music files) may be added to each of the respective Tx slots TS1 to TS4. In this case, the CPUs 30 of the mobile devices 1b to 1d may select and reproduce music data added to predetermined Tx slots among the music data added to the respective Tx slots TS1 to TS4. For example, first music data is added to the Tx slot TS1 of a beacon, second music data is added to the Tx slot TS2, and third music data is added to the Tx slot TS3. Only the data in the Tx slot TS1 may be selected and reproduced on the mobile device 1b, only the data in the Tx slot TS2 may be selected and reproduced on the mobile device 1c, and only the data in the Tx slot TS3 may be selected and reproduced on the mobile device 1d. In accordance therewith, it is possible to reproduce different music on each of the mobile devices 1b to 1d. As a method for selecting and reproducing music data by the CPUs 30 of the mobile devices 1b to 1d, for example, there is a method in which all the data in the respective Tx slots TS1 to TS4 are once retrieved, and thereafter, only data selected in the mobile devices 1b to 1d are outputted to the speakers 36. Instead, there may be a method in which only data in a predetermined Tx slot is received.

In the above embodiment, the music data is used as music data to be added to a beacon. However, the present invention is not limited thereto, and may be configured such that image data is delivered to be viewed on a mobile device.

In the embodiment, the music data is obtained from the memory card 62 connected to the music server 60 via the I/F 61. However, the present invention is not limited thereto. For example, music data may be obtained from a recording medium connected to the music server 60 via, for example, a USB terminal. In addition, music data delivered via the Internet may be obtained.

### [FIG. 3]

1d: CORDLESS TELEPHONE
1c: CORDLESS TELEPHONE
(a): TO EXTERNAL POWER SOURCE
50: CHARGING PLATFORM
49: CONNECTOR
48: POWER SOURCE UNIT
33: ANTENNA
35: MICROPHONE
36: SPEAKER
34: CORDLESS UNIT
37: OPERATION PANEL
51: CORDLESS UNIT
18: ANTENNA
17: AUDIO LSI
3: RECEIVER
20: MODEM
21: BUFFER
22: SCANNER
60: MUSIC SERVER
62: MEMORY CARD
23: ENCODER
24: DECODER
25: PRINTER
4: OPERATION PANEL
27: AMPLIFIER

### [FIG. 4]

S1: NORMAL STATE
S2: IS SERVER IN USE?
S3: DOES MAIN DEVICE PERFORM SETTING?
S4: DOES MOBILE DEVICE PERFORM SETTING?
S5: SELECT MOBILE DEVICE AS DELIVERY DESTINATION
S6: SELECT DELIVERY MODE
S7: SELECT DELIVERY DATA
S8: REPRODUCE
S9: DOES MAIN DEVICE RECEIVE INCOMING CALL?
S10: IS TERMINATION PROCESSING PERFORMED?
S11: TERMINATE REPRODUCTION
S12: DOES MOBILE DEVICE RECEIVE INCOMING CALL?
S13: INCOMING OPERATION
S14: IS TELEPHONE CALL POSSIBLE?
S15: TELEPHONE CALL
S16: TERMINATE TELEPHONE CALL
S17: PROCEED TO VARIOUS DELIVERY MODES

What is claimed is:

1. A telephone system comprising:
a portable device; and
a telephone set with which the portable device can be registered as an additional device,
wherein the telephone system comprises a transmission unit configured to periodically transmit a beacon to the registered portable device, and an adding unit configured to add additional data containing at least one of audio data and visual data to the beacon to be transmitted from the transmission unit, and
wherein the portable device comprises a reproduction unit configured to reproduce the additional data obtained from the beacon.

2. The telephone system according to claim 1, wherein the adding unit is configured to add the additional data to a plurality of slots.

3. The telephone system according to claim 2,
wherein the adding unit of the telephone set is configured to add different additional data to the slot, and
wherein the reproduction unit of the portable device is configured to select and reproduce additional data added to a predetermined slot among the additional data added to the received beacon.

4. The telephone system according to claim 3, wherein the different additional data are based on different files.

5. The telephone system according to claim 1, wherein a plurality of portable devices are allowed to be registered respectively as additional devices with the telephone system.

6. The telephone system according to claim 1, wherein the beacon allows the portable device to be synchronized with the telephone set.

7. The telephone system according to claim 1, wherein the transmission unit is configured to transmit the beacon at regular intervals.

8. A telephone set configured to register and communicate with a portable device as an additional device in a telephone system, said telephone set comprising:
a transmission unit configured to periodically transmit a beacon to the portable device; and
an adding unit configured to add additional data containing at least one of audio data and visual data to the beacon to be transmitted from the transmission unit.

9. A portable device used in a telephone system and configured to communicate with a telephone set that periodically transmit a beacon, said portable device comprising:
a receiving unit configured to receive the beacon;
a obtaining unit configured to obtain an additional data containing at least one of audio data and visual data from the beacon when the additional data is added to the beacon; and
a reproduction unit configured to reproduce the additional data obtained from the beacon.
